(19) United States
(12) Patent Application Publication
(10) Pub. No.: US 2019/0356245 A1
(43) Pub. Date: Nov. 21, 2019

(54) HORSE SADDLE BLANKET

(71) Applicant: Facultad de Ciencias Aplicadas- Universidad Nacional de Pilar, Ciudad Pilar - Neembucu (PY)

(72) Inventors: Emilio Sisul, Ciudad Pilar - Neembucu (PY); Miguel Angel Del Pino Aguayo, Ciudad Pilar - Neembucu (PY); Nelida Blanca Soria Rey, Asuncion (PY); Maria Elva Viveros Chavez, Ciudad Pilar - Neembucu (PY)

(21) Appl. No.: 16/032,483

(22) Filed: Jul. 11, 2018

(30) Foreign Application Priority Data
May 17, 2018 (PY) P 1836507

(51) Int. Cl. H02N 2/18; B68C 1/12

(52) U.S. Cl. CPC H02N 2/186; B68C 1/12

(57) ABSTRACT

A horse saddle blanket, which comprises: a top part that comprises a plurality of springs; a lower part that comprises a plurality of piezoelectric cells aligned with the springs and configured to transform the mechanical energy generated by the pressure of the rider during riding into electrical energy; an energy storage device, responsible for storing the electrical energy generated by the piezoelectric cells; and an outlet connector for the connection and charging of an electronic device.

### CROSS REFERENCE TO RELATED APPLICATION

This application claims priority of Paraguay Application No. P 1836507 PY filed May 17, 2018, application which is incorporated herein by reference.

### FIELD OF THE INVENTION

The present invention falls within the field of energy generation systems in rural environments.

### BACKGROUND OF THE INVENTION

Energy is present in all human activities and its availability is an essential requirement for development. In rural areas, the provision of electrical energy is a limiting factor. As a result of this situation, people who live in rural areas have difficulties to obtain the lighting, communication and many other needs that require consumption of electrical energy.

The existing solutions for producing energy in rural environments incorporate mechanisms such as the obtaining of energy by means of photovoltaic cells, using solar panels, kinetic generators, or by means of the burning of hydrocarbons, which are mechanisms that are neither practical nor easy to use.

The present invention proposes a simple and practical alternative way of producing energy. Taking advantage of the fact that the use of horses is a common and habitual practice in rural zones (for transport or work in the fields), the present invention uses the movement of the horse and the rider that occurs in the daily tasks in the countryside to generate energy.

### DESCRIPTION OF THE INVENTION

The principal objective of the invention is to provide energy to people who work in the rural countryside, because they work during the day making long rides on horseback. To do this, the present invention obtains energy by means of a piezoelectric generator inserted into the horse saddle, thus taking advantage of the energy from the vibration and pressure generated while riding to facilitate the charging of mobile phones or lighting devices, among other possible applications, taking into account that these people work in extensive rural areas and in many cases locations that are far from their places of residence, and they lack a means to access electrical energy or connect to the electrical grid.

The present invention consists of a blanket (the cloth that covers the back of the horse) used for the horse saddle, that contains a piezoelectric generator affixed to it, such that it provides power to the riders who are performing their work by simply storing the energy generated by the movement of the animal (walk, trot, gallop) and the pressure exerted by the rider. This makes it possible to provide energy wherever the horse is, by storing and later supplying the energy by means of a USB outlet connector inserted into the blanket itself.

Specifically, the present invention uses a low-power piezoelectric electrical generator that can be used to power communication or lighting devices (e.g. cell phones, flashlights) connected to a horse saddle, in the saddle blanket, which is an element that is used between the rider and the back of the horse.

More specifically, the object of the invention discloses a blanket that forms part of the saddle, with a piezoelectric generator, in such a way that when the vibration and pressure is generated by the movement of the animal (walk, trot, gallop) and the pressure of the rider, it converts the mechanical energy into electrical energy.

The horse saddle blanket of the present invention comprises a top part that comprises a plurality of springs; a lower part that comprises a plurality of piezoelectric cells aligned with the springs and configured to transform the mechanical energy generated by the pressure of the rider during riding into electrical energy; an energy storage device, that is responsible for storing the electrical energy generated by the piezoelectric cells; and an outlet connector for the connection and charging of an electronic device.

In one embodiment, the top part comprises a plastic base and a plurality of rubber pieces affixed to the base, and wherein the springs are secured to the rubber pieces. The lower part may comprise a plurality of screws in contact with one side of the piezoelectric cells, with the screws connected electrically to a first common electrode.

In one embodiment, the blanket comprises a rectifier configured to rectify the electrical energy generated by the piezoelectric cells. The outlet connector is preferably a USB connector. The energy storage device may be, for example, a capacitor or capacitor bank.

The present invention provides a very practical and simple way to obtain energy, taking advantage of the energy generated by the movement of the animal and the rider, by simply performing the work that is typical in rural areas, in such a way that the people who work in these zones can access the energy required to maintain communications or lighting.

### BRIEF DESCRIPTION OF THE DRAWINGS

The following is a very brief description of a series of drawings that help provide a better understanding of the invention and that are expressly related to an embodiment of said invention that is presented as an example but not for the purposes of limitation.

FIG. 1 shows a basic schematic diagram of the horse saddle blanket with a piezoelectric generator according to the present invention.

FIG. 2 illustrates the top part of the blanket, with the rubber pieces and springs secured to them.

FIG. 3 shows the lower part of the blanket, with the screws and the piezoelectric cells.

### DETAILED DESCRIPTION OF THE INVENTION

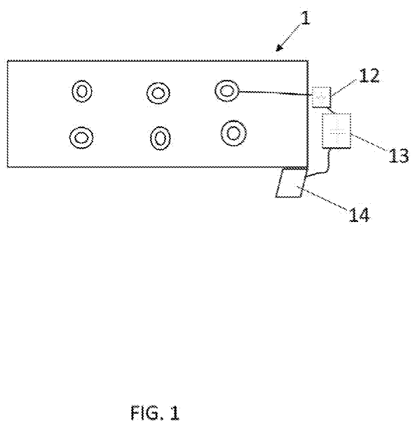

The present invention discloses a blanket that forms part of the saddle for equines, which incorporates a piezoelectric generator, which is responsible for converting mechanical energy into electrical energy. FIG. 1 shows a very schematic view of the horse saddle blanket 1 with the piezoelectric generator and some of its electronic components.

The blanket may be made of a plastic material covered with foam rubber and fabric, similar to those used in the insoles of sports footwear, which does not affect its function of protecting the horse.

The blanket 1 has two parts, a top part where the springs are located and a lower part where the piezoelectric cells of the generator are inserted.

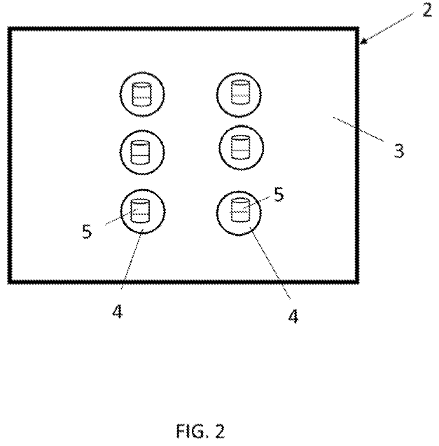

FIG. 2 shows a view of the top part 2 of the blanket 1 for horses, into which a template with rubber pieces arranged in parallel arrangements with springs, to exert pressure, is inserted. The top part has a base 3 plastic base to which several rubber pieces 4 are affixed (six rubber pieces, in the example in FIG. 2, although the quantity and arrangement may be different), spaced apart from each other and preferably distributed uniformly on the base, to which several springs 5 are affixed that exert pressure on several piezoelectric cells positioned on the lower part of the blanket when riding, and which constitute one of the energy outputs.

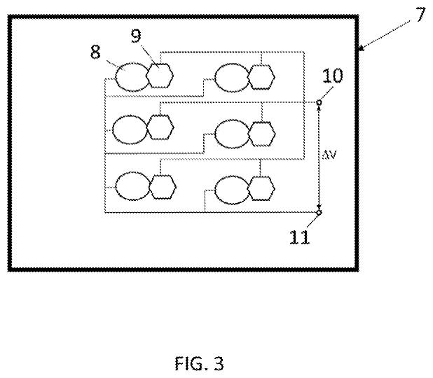

FIG. 3 shows a view of the lower part 7 of the blanket 1 with piezoelectric cells 8 arranged on several screws 9 that serve as electrodes that will send the energy generated by the pressure of the rider during riding to a rectifier. The piezoelectric cells 8 are made of a piezoelectric material with the property of generating a potential difference (ΔV) between its opposing surfaces when subjected to mechanical pressure.

On the lower part 7 of the blanket 1, several screws 9 are inserted (six screws, in the example of FIG. 3, although the quantity and arrangement may be different) connected in parallel and which serve as a first common electrode 10 and constitute one of the outputs of the generated energy.

The other output is constituted by a connector, a second common electrode 11, which connects the surfaces of the piezoelectric cells 8 that are opposite the contact surfaces of the screws 9. Thus a potential difference (ΔV) is generated between the two electrodes (10, 11) when the piezoelectric cells 8 are subjected to a mechanical stress. Said electrodes (10, 11) are connected through several cables to a rectifier 12 and to an energy storage device 13 (implemented, for example, in a capacitor or a capacitor bank), which will store the energy generated by the piezoelectric cells 8.

The energy storage device 13 is preferably located on one side of the blanket 1, in order to avoid bothering the rider or the horse. The energy storage device 13 acts as a source of direct current to charge electronic devices, being in electrical contact with an outlet connector 14, preferably a USB connector. Said outlet connector 14 is used to connect different devices (smartphones, LED lighting devices, communication devices, etc.) and to charge them. Voltage stabilizer or voltage conversion elements may also be included in the blanket 1 itself to provide a stable output voltage or an output voltage of a particular magnitude.

The blanket will be made of a plastic material covered with foam rubber and fabric, on which 6 piezoelectric cells are placed, with 6 screws inserted underneath, connected in parallel to serve as the common electrode and constitute the energy outlet.

1. A horse saddle blanket, comprising:
a top part that comprises a plurality of springs;
a lower part that comprises a plurality of piezoelectric cells aligned with the springs and configured to transform the mechanical energy generated by the pressure of the rider during riding into electrical energy;
an energy storage device, responsible for storing the electrical energy generated by the piezoelectric cells; and
an outlet connector for the connection and charging of an electronic device.

2. The blanket according to claim 1, wherein the top part comprises a plastic base and a plurality of rubber pieces affixed to the base, and wherein the springs are secured to the rubber pieces.

3. The blanket according to claim 1, wherein the lower part comprises a plurality of screws in contact with one side of the piezoelectric cells, with the screws connected electrically to a first common electrode.

4. The blanket according to claim 1, which comprises a rectifier configured to rectify the electrical energy generated by the piezoelectric cells.

5. The blanket according to claim 1, wherein the outlet connector is a USB connector.

6. The blanket according to claim 1, wherein the energy storage device is a capacitor or capacitor bank.
